(19) United States
(12) Patent Application Publication
(10) Pub. No.: US 2009/0295559 A1
(43) Pub. Date: Dec. 3, 2009

(54) INTEGRATED HIERARCHICAL PROCESS FOR FAULT DETECTION AND ISOLATION

(75) Inventors: Mark N. Howell, Rochester Hills, MI (US); Mutasim A. Salman, Rochester Hills, MI (US); Xidong Tang, Sterling Heights, MI (US); Xiaodong Zhang, Mason, OH (US); Yilu Zhang, Northville, MI (US); Yuen-Kwok Chin, Troy, MI (US); William C. Lin, Birmingham, MI (US); Rami I. Debouk, Dearborn, MI (US); Steven W. Holland, St. Clair, MI (US); Sugato Chakrabarty, Bangalore (IN); Rahul Chougule, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/131,347

(22) Filed: Jun. 2, 2008

(51) Int. Cl. B60Q 1/00

(52) U.S. Cl. 340/459

(57) ABSTRACT

A system and method for determining the root cause of a fault in a vehicle system, sub-system or component using models and observations. In one embodiment, a hierarchical tree is employed to combine trouble or diagnostic codes from multiple sub-systems and components to get a confidence estimate of whether a certain diagnostic code is accurately giving an indication of problem with a particular sub-system or component. In another embodiment, a hierarchical diagnosis network is employed that relies on the theory of hierarchical information whereby at any level of the network only the required abstracted information is being used for decision making. In another embodiment, a graph-based diagnosis and prognosis system is employed that includes a plurality of nodes interconnected by information pathways. The nodes are fault diagnosis and fault prognosis nodes for components or sub-systems, and contain fault and state-of-health diagnosis and reasoning modules.

### BACKGROUND OF THE INVENTION

1. Field of the Invention

This invention relates generally to a system and method for determining the root cause of faults in a vehicle system and, more particularly, to a system and method for determining the root cause of faults in a vehicle system and isolating the fault, where the system and method use multiple models and observations in a hierarchical tree to provide a confidence estimate of the source of a particular fault.

2. Discussion of the Related Art

Modern vehicles include many electrical vehicle systems, such as vehicle stability control systems. For example, certain vehicle stability systems employ automatic braking in response to an undesired turning or yaw of the vehicle. Some vehicle stability systems employ active front-wheel or rear-wheel steering that assist the vehicle operator in steering the vehicle in response to the detected rotation of the steering wheel. Some vehicle stability systems employ active suspension systems that change the vehicle suspension in response to road conditions and other vehicle operating conditions.

Diagnostics monitoring of vehicle stability systems is an important vehicle design consideration so as to be able to quickly detect system faults, and isolate the faults for maintenance and service purposes. These stability systems typically employ various sub-systems, actuators and sensors, such as yaw rate sensors, lateral acceleration sensors, steering hand-wheel angle sensors, etc., that are used to help provide control of the vehicle. If any of the sensors, actuators and sub-systems associated with these systems fail, it is desirable to quickly detect the fault and activate fail-safe strategies so as to prevent the system from improperly responding to a perceived, but false condition. It is also desirable to isolate the defective sensor, actuator or sub-system for maintenance, service and replacement purposes. Thus, it is necessary to monitor the various sensors, actuators and sub-systems employed in these systems to identify a failure.

It is a design challenge to identify the root cause of a fault and isolate the fault all the way down to the component level, or even the sub-system level, in a vehicle system. The various sub-systems and components in a vehicle system, such as vehicle brake system or a vehicle steering system, are typically not designed by the vehicle manufacturer, but are provided by an outside source. Because of this, these components and sub-systems may not have knowledge of what other sub-systems or components are doing in the overall vehicle system, but will only know how their particular sub-system or component is operating. Thus, these outside sub-systems or components may know that they are not operating properly, but will not know if their component or sub-system is faulty or another sub-system or component is faulty. For example, a vehicle may be pulling in one direction, which may be the result of a brake problem or a steering problem. However, because the brake system and the steering system do not know whether the other is operating properly, the overall vehicle system may not be able to identify the root cause of that problem.

Each individual sub-system or component may issue a diagnostic trouble code indicating a problem when they are not operating properly, but this trouble code may not be a result of a problem with the sub-system or component issuing the code. In otherwords, the diagnostic code may be set because the sub-system or component is not operating properly, but that operation may be the result of another sub-system or component not operating properly. It is desirable to know how reliable the diagnostics codes are from a particular sub-system or component to determine whether that sub-system or component is the fault of a problem.

### SUMMARY OF THE INVENTION

In accordance with the teachings of the present invention, a system and method are disclosed for determining the root cause of a fault in a vehicle system, sub-system or component using models and observations. In one embodiment, a hierarchical tree is employed to combine trouble or diagnostic codes from multiple sub-systems and components to get a confidence estimate of whether a certain diagnostic code is accurately giving an indication of problem with a particular sub-system or component. In another embodiment, a hierarchical diagnosis network is employed that relies on the theory of hierarchical information whereby at any level of the network only the required abstracted information is being used for decision making. In another embodiment, a graph-based diagnosis and prognosis system is employed that includes a plurality of nodes interconnected by information pathways. The nodes are fault diagnosis and fault prognosis nodes for components or sub-systems, and contain fault and state-of-health diagnosis and reasoning modules.

Additional features of the present invention will become apparent from the following description and appended claims taken in conjunction with the accompanying drawings.

### BRIEF DESCRIPTION OF THE DRAWINGS

FIG. 1 is a hierarchical tree for analyzing diagnostic codes from vehicle systems, sub-systems and components, according to an embodiment of the present invention;

FIG. 2 is a hierarchical diagnosis network for estimating confidence levels of diagnostic codes for diagnosis and prognosis purposes in a vehicle, according to an embodiment of the present invention; and

FIG. 3 is a graph-based diagnosis and prognosis system for a vehicle, according to an embodiment of the present invention.

### DETAILED DESCRIPTION OF THE EMBODIMENTS

The following discussion of the embodiments of the invention directed to a system and method for identifying a confidence estimate of whether a vehicle sub-system or component is the root cause of a particular fault is merely exemplary in nature, and is in no way intended to limit the invention or its applications or uses.

The present invention proposes a process for determining the root cause of a fault in a vehicle by using multiple models and observations. Each of the models provides a confidence estimate about the observation it makes regarding a potential fault condition. As will be discussed in detail below, the invention can use a hierarchical tree to analyze diagnostic codes and other signals from sub-systems and components. Each level of the hierarchical tree accesses the information it has before making a decision. The information from different branches of the tree can be dynamically altered based on vehicle information, such as speed dependency. The model confidence estimates can also be determined using data from multiple vehicles. The information can be combined together by various methods, such as statistical techniques, for example, Dempster-Shafer theory or Bayes theory. The hierarchical architecture is scalable and flexible, thus enabling the dynamic integration of multiple faults.

Information flows up the hierarchical tree from sub-system and component decision makers that make the decisions based on local information. The overall vehicle state of health can be determined by looking at the top level of the tree. Each branch can represent a different sub-system, such as engine, electrical, steering, braking, etc., and the state-of-health of these sub-systems can be determined together with a confidence in the assessment. Information in the tree can also be used to replace components that are weakening the overall vehicle health.

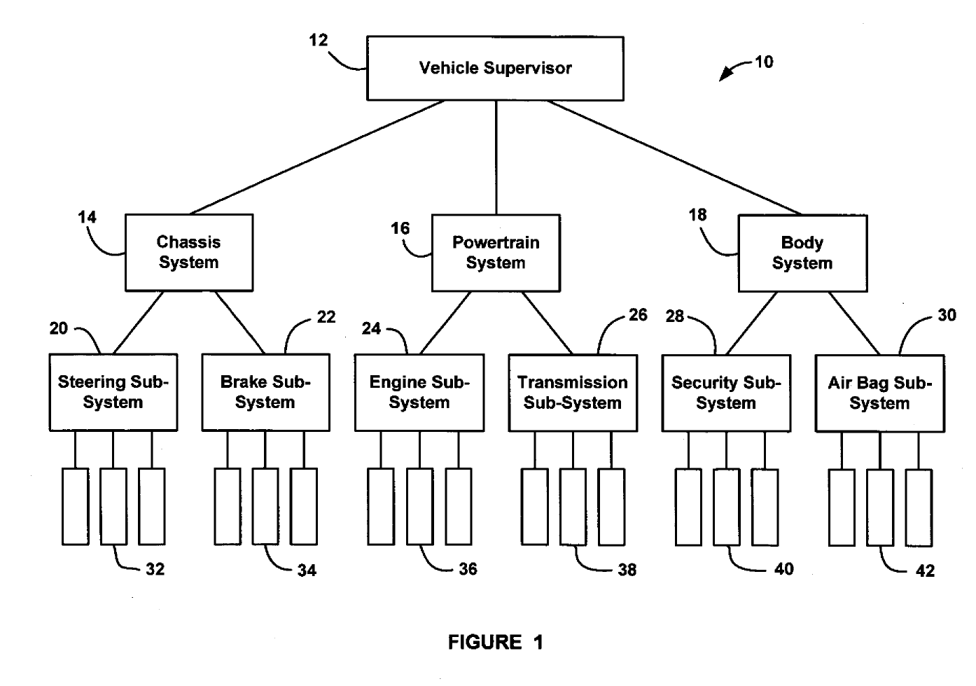

FIG. 1 is a hierarchical tree 10 of the type discussed above, according to an embodiment of the present invention. The tree 10 includes four layers, where a top layer is a vehicle supervisor 12 that ultimately determines the source of a fault using the information that it receives. The tree 10 is broken down into three systems, namely a vehicle chassis system 14, a vehicle powertrain system 16 and a vehicle body system 18. Each separate system 14, 16 and 18 can be separated into its representative sub-systems at a third level. For example, the chassis system 14 can be separated into a steering sub-system 20 and a braking sub-system 22, the powertrain system 16 can be separated into an engine sub-system 24 and a transmission sub-system 26, and the body system 18 can be separated into a security sub-system 28 and an air bag sub-system 30. Each sub-system 20-30 includes components at a fourth level of the tree 10, and can be any suitable component in that particular sub-system. For example, the steering sub-system includes components 32, such as a hand wheel angle (HWA) sensor. Likewise, the brake sub-system 22 includes components 34, the engine sub-system 24 includes components 36, the transmission sub-system 26 includes components 38, and the security sub-system 28 includes components 40 and the air bag sub-system 30 includes components 42 The tree 10 can be extended to other levels below the fourth level of the components 32-42 if the sub-systems and components can be separated.

Each of the components 32-42, the sub-systems 20-30, the systems 14, 16 and 18 and the vehicle supervisor 12 employ various algorithms that analyze vehicle diagnostic codes, trouble codes and other information and data. These algorithms include decision making algorithms that provide a confidence estimate as to whether a particular component 32-42, sub-system 20-30 or system 14, 16 and 18 has a particular fault or a potential fault. For example, signals from the components 32-42 are sent to their respective sub-system 20-30, and include diagnostic codes if a potential fault with the component occurs. Further, the components 32-34 include algorithms that provide additional signals sent with the diagnostic code that include the confidence estimate signal as to how confident the particular component is that the fault is occurring in that component. As the information goes up to the next level, algorithms at the sub-system level can then assess based on all of the signals it is receiving from its components as to whether one of those components has a fault using the diagnosis signals and the confidence estimate signals. The sub-systems 20-30 will then send diagnostic signals and confidence estimate signals to the system level, where the system 14, 16 or 18 will use the signals from all of its sub-systems 20-30 to determine where a fault may exist based on the confidence estimate signals and the diagnostic codes. Thus, the system 14,16 and 18 will know whether one of the components 32-42 is faulty in its system hierarchical path, and can also determine whether a particular sub-system 20-30 includes a fault with some level of confidence. The signals from the system 14, 16 and 18 are then sent to the vehicle supervisor 12 that includes supervisory algorithms to monitor all the signals from all of the systems 14, 16 and 18.

The tree 10 can be used to isolate faults. This can be determined in a number of ways. The most probable fault can be determined by determining the fault path down the tree 10. The decision makers in the hierarchical tree 10 will be implemented in real-time. The decision makers can be of any form, for example, parity equations, Kalman filters, fuzzy models, neural networks, etc. Thus, as information flows up the tree 10, decision making algorithms in each of the levels can analyze the information to determine the confidence level as to what sub-system or component may have a fault. This confidence level can be analyzed statistically using various processes, such as the Dempster-Shafer theory or Bayes theory.

The broader availability of state information at the vehicle level may enable the ability to diagnose failures with better coverage than using information at the sub-system level or component level alone. The hypothesis is that as sub-system interactions increase, a vehicle-level approach to diagnostics will be increasingly more important. Diagnosis of current vehicle systems is symptom driven, that is, following an observation of an unexpected event and/or measurement, a trouble code is issued and detection is required to isolate the cause of the fault. With the introduction of intelligent controlled systems, a detection problem becomes more complex, especially when multiple systems are interacting with each other. A combination of hierarchical and/or a distributed diagnosis approaches may be helpful in reducing the complexity of the isolation algorithms. This comes at the expense of additional processing and communication among involved systems, as well as memory requirements to store information, particularly if the diagnosis is done on-board.

Hierarchical diagnosis relies on the theory of hierarchical information whereby at any level only the required abstracted information is being used for decision making. The highest level is in charge of making the diagnostic decisions. For example, at the component level currents and voltages may be used to understand the state of health of an electrical component. Therefore, local and existing diagnostic algorithms/procedures would provide information that will be extracted for use by a higher level in the hierarchy. The challenge is finding the correct abstraction so that the information is not lost. Two layers may be enough, but more may be added depending on the complexity of the system diagnosed.

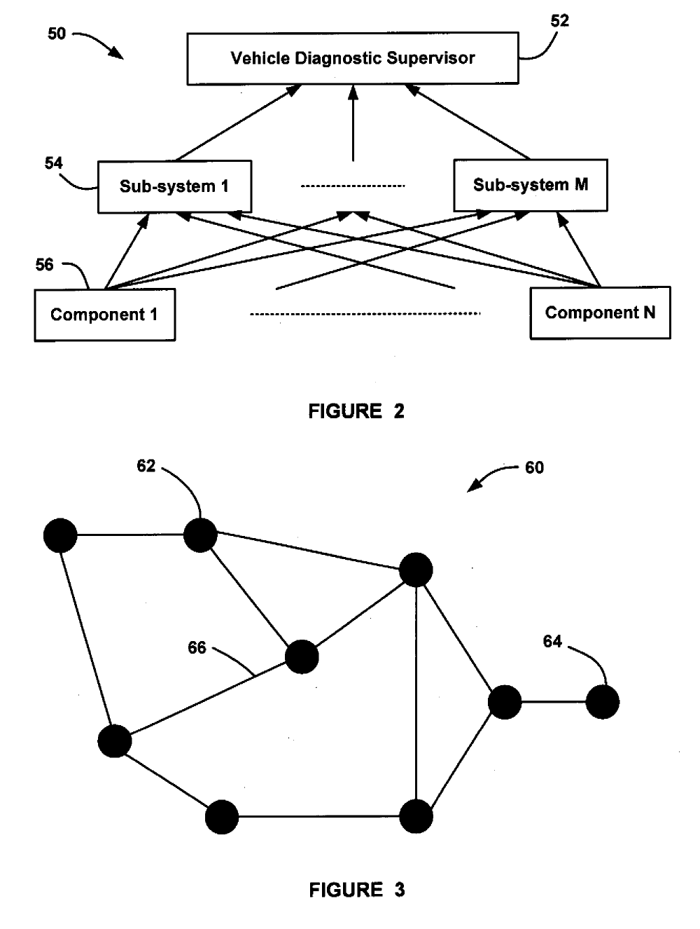

FIG. 2 is a block diagram of a hierarchical diagnosis network 50 of the type discussed above, according to another embodiment of the present invention. The network 50 includes a vehicle diagnostic supervisor 52 at the top of the network 50 that receives signals from a plurality of sub-system 54. Likewise, the sub-systems 54 each receive signals from all or most of the components in the network 50. As with the hierarchy tree 10, signals with diagnostic codes, confidence estimates and other information and data are passed up the network 50 from the component level to the sub-system level and then to the supervisor 52 so that the supervisor 52 can make a determination of where a particular problem within the vehicle exists at a certain confidence level so that appropriate action can be taken.

Distributed diagnosis may be used to overcome the problem of gathering failure information at one location in order to make a decision about the occurrence of a failure in a vehicle system sub-system or component. Such techniques rely on exchanging information among a set of nodes and devising a set of rules to infer the occurrence of the failure based on the exchanged information.

The integrated fault detection and isolation process of the invention can also be extended to create not necessarily a tree, but a graph of the system or sub-system interactions. Such a graph can provide an analysis to determine the most probable cause of a failure in real time. This is because some sub-systems may have multiple parents, for example, a sub-system may be both electrical and mechanical. Thus, a fault may be isolated by doing a search in the graph. Techniques such as fuzzy logic, Shafer-Dempster processes, etc. can be applied to find the best possible path as there may be multiple paths through the graph for a specific situation.

FIG. 3 is a graph-based diagnosis and prognosis system 60 of the type discussed above, according to another embodiment of the present invention. The system 60 includes a plurality of nodes 62, including a root node 64, interconnected by information pathways 66. The nodes 62 are fault diagnosis and fault prognosis nodes for components or sub-systems, and contain fault and state-of-health diagnosis and reasoning modules. The reasoning modules collate information received using, for example, fuzzy logic, neural networks, etc. The reasoning modules process the information about the faults they know of based on the local view of the total system, and forward the information, including fault estimation and health estimation, and signals for estimating the accuracy of the information, along the information pathways 66 to the other nodes 62 to which they are connected. The receiving nodes 62 may have additional local information and will make different decisions based on the information flowing to them. The graph is dynamic with nodes entering and leaving the system 60. This happens when the system changes to a different state or one of the nodes 62 detects a fault and shuts down.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for providing fault detection and isolation in a vehicle, said method comprising:
separating the vehicle into a plurality of systems, a plurality of sub-systems and a plurality of components;
categorizing the systems, sub-systems and components into a hierarchical tree having levels where each system receives signals from a plurality of sub-systems at a lower level than the plurality of systems and each sub-system receives signals from a plurality of components at a lower level than the sub-systems;
employing algorithms in the systems, sub-systems and components that provide and analyze diagnostic codes, trouble codes and other information to provide confidence estimate signals as to the likelihood that a particular sub-system or component has failed;
sending signals from the components to the sub-systems and from the sub-systems to the systems that include the confidence estimate signals;
analyzing the confidence estimate signals in the plurality of systems to attempt to isolate a fault; and
sending signals to a supervisor at the top of the tree that identifies a particular fault with a certain level of confidence.

2. The method according to claim 1 wherein employing algorithms includes employing statistical algorithms.

3. The method according to claim 2 wherein employing statistical algorithms includes employing algorithms selected from the group consisting of Dempster-Shafer theory algorithms and Bayes theory algorithms.

4. The method according to claim 2 wherein employing statistical algorithms includes employing algorithms selected from the group consisting of parity equations, Kalman filters, fuzzy models and neural networks.

5. The method according to claim 1 wherein separating the vehicle into a plurality of systems includes separating the vehicle into a chassis system, a powertrain system and a body system.

6. The method according to claim 5 wherein separating the vehicle into a plurality of sub-systems includes separating the vehicle into a steering sub-system and a brake sub-system that are part of the chassis system, an engine sub-system and a transmission sub-system that are part of the powertrain system and a security sub-system and an air bag sub-system that are part of the body system.

7. The method according to claim 6 wherein separating the vehicle into components includes separating the vehicle into sensors and detectors.

8. The method according to claim 1 wherein categorizing the systems, sub-systems and components includes categorizing the systems, sub-systems and components into a hierarchical diagnosis network where the components provide signals to all of the sub-systems.

9. A method for providing fault detection and isolation in a vehicle, said method comprising:
identifying a plurality of systems, a plurality of sub-systems and a plurality of components in the vehicle;
employing algorithms in the systems, sub-systems and components that provide and analyze diagnostic codes, trouble codes and other information to provide confidence estimate signals as to the likelihood that a particular sub-system or component has failed;
sending the confidence estimate signals between and among the plurality of systems, the plurality of sub-systems and the plurality of components; and
analyzing the confidence estimate signals in the plurality of systems and sub-systems to attempt to identify and isolate a fault.

10. The method according to claim 9 further comprising categorizing the systems, sub-systems and components into a hierarchical tree having levels where each system receives signals from a plurality of sub-systems at a lower level than the plurality of systems and each sub-system receives signals from a plurality of components at a lower level than the sub-systems.

11. The method according to claim 10 further comprising sending signals to a supervisor at the top of the tree that identifies a particular fault with a certain level of confidence.

12. The method according to claim 9 further comprising categorizing the systems, sub-systems and components into a hierarchical diagnosis network where the components provide signals to all of the sub-systems.

13. The method according to claim 9 further comprising categorizing the systems, sub-systems and components into a graph-based diagnosis and prognosis system that includes a plurality of nodes interconnected by information pathways, where the nodes are fault diagnosis and fault prognosis nodes for components or sub-systems, and contain fault and state-of-health diagnosis and reasoning modules.

14. The method according to claim 9 wherein employing algorithms includes employing statistical algorithms.

15. The method according to claim 14 wherein employing statistical algorithms includes employing algorithms selected from the group consisting of Dempster-Shafer theory algorithms and Bayes theory algorithms.

16. The method according to claim 14 wherein employing statistical algorithms includes employing algorithms selected from the group consisting of parity equations, Kalman filters, fuzzy models and neural networks.

17. A fault diagnosis system for providing fault detection and isolation in a vehicle, said system comprising:
means for identifying a plurality of vehicle systems, a plurality of sub-systems and a plurality of components in the vehicle;
means for employing algorithms in the vehicle systems, sub-systems and components that provide and analyze diagnostic codes, trouble codes and other information to provide confidence estimate signals as to the likelihood that a particular sub-system or component has failed;
means for sending the confidence estimate signals between and among the plurality of vehicle systems, the plurality of sub-systems and the plurality of components; and
means for analyzing the confidence estimate signals in the plurality of vehicle systems and sub-systems to attempt to identify and isolate a fault.

18. The fault diagnosis system according to claim 17 further comprising means for categorizing the vehicle systems, sub-systems and components into a hierarchical tree having levels where each system receives signals from a plurality of sub-systems at a lower level than the plurality of systems and each sub-system receives signals from a plurality of components at a lower level than the sub-systems.

19. The fault diagnosis system according to claim 17 further comprising means for categorizing the vehicle systems, sub-systems and components into a hierarchical diagnosis network where the components provide signals to all of the sub-systems.

20. The fault diagnosis system according to claim 17 further comprising means for categorizing the vehicle systems, sub-systems and components into a graph-based diagnosis and prognosis system that includes a plurality of nodes interconnected by information pathways, where the nodes are fault diagnosis and fault prognosis nodes for components or sub-systems, and contain fault and state-of-health diagnosis and reasoning modules.
